(19) United States
(12) Patent Application Publication
(10) Pub. No.: US 2009/0011656 A1
(43) Pub. Date: Jan. 8, 2009

(54) INSTRUMENTATION KIT OF A BICYCLE AND BICYCLE COMPRISING SUCH KIT

(75) Inventor: Giuseppe Dal Pra', Zane (Vicenza) (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: CAMPAGNOLO S.r.I., Vicenza (IT)

(21) Appl. No.: 12/136,993

(22) Filed: Jun. 11, 2008

(30) Foreign Application Priority Data
Jul. 6, 2007 (IT) MI2007A001352

(51) Int. Cl. H01R 24/06

(52) U.S. Cl. 439/669

(57) ABSTRACT

An instrumentation kit of a bicycle comprises a bundle of cables for electrically connecting a first electronic component of the kit to a second electronic component of the kit, the cables of the bundle being cut off to form a first bundle portion and a second bundle portion. The first bundle portion and the second bundle portion are connectible to each other through a common connector. A bicycle comprising the instrumentation kit, a bottle holder and a containment box for an electronic component of the instrumentation kit are also described.

### FIELD OF THE INVENTION

The present invention refers to an instrumentation kit of a bicycle. In particular, the invention refers to an instrumentation kit comprising at least two electronic components, typically part of an on-board computer of the bicycle, electrically connected to each other through at least one cable.

### SUMMARY

In the field of high-performance bicycles it is becoming common practice to use on-board computers, through which it is possible to detect and display, information on the operating state of the bicycle and/or interact with equipments thereof, such as the front and/or rear derailleur to manage gearshifting.

Known instrument-equipped bicycles are made by equipping conventional bicycles with the necessary electronic components and relative electrical connection cables. This procedure creates numerous difficulties, as a conventional bicycle is not generally set up to house the aforementioned electronic components and connection cables.

Moreover, when arranged on the outside, the electrical cables can easily be damaged, and affect the aesthetic appearance of the bicycle.

The invention refers to an instrumentation kit of a bicycle comprising a bundle of cables for electrically connecting a first electronic component of the kit to a second electronic component of the kit, the cables of the bundle being cut off to form a first bundle portion and a second bundle portion, wherein said first bundle portion and said second bundle portion are connectible to each other through a common connector.

### BRIEF DESCRIPTION OF THE DRAWINGS

Further characteristics of the present invention shall become clearer from the following detailed description that references the attached drawings. In such drawings:

FIG. 1 is a schematic view of a bicycle comprising an instrumentation kit according to the present invention.

FIG. 2 is a schematic representation of an instrumentation kit according to the present invention.

FIG. 3 is an enlarged schematic view of two portions of a bundle of cables connected through a common connector of the instrumentation kit of FIG. 2.

FIGS. 4-7 are schematic representations of respective alternative embodiments of the instrumentation kit of FIG. 2.

FIG. 8 is a schematic enlarged perspective view of two portions of a bundle of cables comprising a common connector of the instrumentation kit of FIG. 2, which shows the connector in an unconnected configuration.

FIG. 9 is a schematic exploded perspective view of a bottle holder that can be used on the bicycle of FIG. 1.

FIGS. 10 and 11 are schematic enlarged views of the two portions of bundle of cables of FIG. 3, which show possible mutual arrangements of insulating sheaths of the bundle portions and of the common connector according to the present invention.

### DETAILED DESCRIPTION OF THE EMBODIMENTS

### Introduction to the Embodiments

Because the connector is located between two portions of the bundle of cables and not at an end of the bundle, it can be housed in the frame together with the cables while the connection procedure is substantially simplified because there is a single connector for a plurality of cables that are part of the bundle. In this way, the connection can be carried out by typical staff in any bicycle shop, without the risk of confusing cables. Moreover, given that the terminations of the cable portions are held in the same connector, they do not hinder the insertion movement of the bundles of cables in the frame, as happens when using the free terminations of the prior art.

Preferably, the common connector comprises a first connector element associated with the first bundle portion and a second connector element associated with the second bundle portion and said first and second connector element are adapted to be coupled to each other in a single coupling configuration.

Assembly is thus sped up because it is not necessary to carry out connection tests.

In a preferred embodiment of the instrumentation kit of the invention at least one of said first and second electronic components of the kit is electrically connected to a third electronic component of the kit through a further bundle of cables.

Preferably, also said further bundle of cables is cut off to form a first bundle portion and a second bundle portion, which can be connected through a common connector.

Preferably, the first bundle portion of said bundle of cables and the first bundle portion of said further bundle of cables are both associated with said first connector element and the second bundle portion of said bundle of cables and the second bundle portion of said further bundle of cables are respectively associated with two distinct second connector elements.

Preferably, said two distinct second connector elements are suitable for being coupled with said first connector element in a single coupling configuration.

In an embodiment of the instrumentation kit of the invention said bundle of cables is fixedly connected to at least one of said first and second electronic component of the kit.

In an alternative embodiment of the instrumentation kit of the invention, said bundle of cables is removably connectible to at least one of said first and second electronic component of the kit.

Preferably, a stable connection is established between said first and second connector elements through an insertion force required to mate said first and second connector elements (30a, 30a′, 30a″, 30a′″, 30b, 30b′, 30b″, 30b′″).

In this way it is always ensured that the connection is effective, even without auxiliary means for holding the parts of the connector, like a heat-shrinking sheath, or before the application thereof.

Preferably, said common connector is of a non-impermeable type, i.e. it does not have its own sealing structure against the wet.

In this way the size of the connector is smaller than a corresponding impermeable connector. It is thus possible to make holes in the frame that are not very invasive for the passage of the cables and the connectors, to ensure the structural strength of the bicycle remains high. This provision is possible because the frame of the bicycle is a low-humidity environment making an impermeable connection unnecessary.

Preferably, said bundle of cables comprises from two to twenty-four cables, more preferably from two to seven cables.

Preferably, each cable of said first and second bundle of cables is covered by a respective first insulating sheath.

Preferably, said first and second bundle portion are wrapped in a respective second insulating sheath.

In a preferred embodiment of the invention, the instrumentation kit comprises a third insulating sheath that covers said common connector when said first and second bundle portion are connected.

The third insulating sheath allows a non-impermeable connector to be made impermeable, without any appreciable increase in its cross-section.

Preferably, the third insulating sheath overlaps with said first or second insulating sheath for at least a portion of said first and second bundle portion close to said common connector, or vice-versa.

This avoids moisture from penetrating the sections of the cable portions or cable bundle portions close to the connector, where the first and/or second insulating sheath may have been partially removed to allow the attachment of the connector to the cable, and reaching the electronic components.

Preferably, the second insulating sheath completely covers the third insulating sheath.

Preferably, the third insulating sheath is made of a heat-shrinking material.

The use of such a material ensures that a substantially complete adhesion of the third insulating sheath to the connector and to the sections adjacent of said first and second bundle portion is obtained in a simple way.

Preferably, a fourth insulating sheath completely covers said first and second bundle portion connected by the common connector and the common connector.

Preferably, said first or second or fourth insulating sheath is made of a polymeric material having a Shore A hardness between about 5 and 40, more preferably between about 10 and 20.

Insulating sheaths having such characteristics are relatively soft and help in avoiding disturbing noises from the impact of the bundles of cables housed inside the bicycle against the frame caused by vibration during use.

Preferably, the polymeric material is a silicon-based material.

Preferably, the first, second, third or fourth insulating sheaths have a thickness between about 0.1 and 1 mm.

Preferably, the maximum size at a cross-section of said common connector covered by one or more insulating sheaths is between about 5 and about 7 mm.

In an embodiment of the instrumentation kit of the invention at least one of said first and second bundle portion is fixedly connected to a respective component of said first and second electronic component.

In this embodiment at least one of said first and second bundle portion is connected to a respective component of said two electronic components through welding or crimping.

In an alternative embodiment of the instrumentation kit of the invention at least one of said first and second bundle portion is removably connectible to a respective component of said first and second electronic component.

Even when the instrumentation kit is installed on a bicycle, the aforementioned electronic component may be freely disconnected and removed, for example to download data stored in it, to secure it when temporarily not in use, or for repair or replacement, without needing to remove the bundle portion connected to the electronic component.

In the aforementioned alternative embodiment, at least one of said first and second bundle portion is connectible to a respective component of said first and second electronic component through at least one terminal board or at least one connector.

More preferably, said at least one connector is a connector of an impermeable type.

The choice of a connector of an impermeable type is used because the connector that connects a bundle portion to a respective electronic component is normally arranged outside the bicycle, close to or even, in some cases, partially integrated with the electronic component and therefore it is directly exposed to atmospheric agents.

Preferably, said first and second connector elements comprise respective engagement elements adapted to cooperate to lock the connector in the configuration in which said first and second bundle portion are connected together.

The engagement means make it possible to make a stable and secure connection between the first and the second connector element, avoiding their accidental disconnection, especially during the application of an insulating sheath to the connection.

More preferably, one of the first and the second connector element comprises a projection and the other comprises a recess suitable for receiving said projection.

Preferably, said bundle of cables comprises a section exceeding the length required to connect said first and second electronic component when installed on said bicycle.

Preferably, said common connector is associated with said bundle of cables at said exceeding section.

The exceeding section allows the connection of the first and second bundle portion, and possibly the application of an insulating sheath to the connector, in a comfortable position, outside of the bicycle, where it may be subsequently inserted inside the bicycle.

Preferably, the instrumentation kit comprises a collecting space provided to house said exceeding section of the bundle of cables.

Preferably, the collecting space comprises at least one separator element adapted to separate a plurality of bundles of cables housed in the space from each other.

In an embodiment of the instrumentation kit of the invention, the collecting space is defined at a bottle holder of the bicycle.

Preferably, the collecting space is integrated in said bottle holder.

More preferably, the bottle holder comprises a base support portion and a side support portion intended to be fixed to the frame of the bicycle, and the collecting space is defined in said side support portion.

With this arrangement a wall portion of the frame is used to close the collecting space upon mounting of the bottle holder on the bicycle.

In order to ensure the tight seal of the collecting space, the bottle holder preferably comprises a tight seal gasket associated with said side support portion at a peripheral edge of the collecting space.

Preferably, the base support portion of the bottle holder comprises a space adapted to receive an electronic component, for example said first or second electronic component.

More preferably, such an electronic component is a control unit.

Preferably, the base support portion of the bottle holder is tightly sealed at at least one of its sides through a removable cover.

Preferably, the aforementioned electronic component is provided with a power supply unit and the power supply unit is associated with the removable cover.

This allows a bicycle to be equipped with the instrumentation kit of the invention simply and with minimal impact on the structural and aesthetic characteristics of the bicycle. At the same time, it is ensured that a user or operator has very easy access to the main components of the kit for the maintenance or removal thereof.

In another embodiment of the instrumentation kit of the invention the collecting space can be defined at the frame of the bicycle.

In a further embodiment of the instrumentation kit of the invention the collecting space can be defined at the handlebars of the bicycle.

In a further embodiment of the instrumentation kit of the invention the collecting space can be defined at a seat post of the bicycle.

In a further embodiment of the instrumentation kit of the invention the collecting space can be associated with one of the aforementioned two electronic components.

Preferably, said first and second electronic component comprise a control unit and a display of an on-board computer of said bicycle.

Preferably, said control unit comprises a logic unit and a power unit for controlling actuators.

In an embodiment thereof, the instrumentation kit of the invention comprises a first bundle of cables to electrically connect the control unit and the display and said first bundle of cables is fixedly connected to the control unit and to the display.

In an alternative embodiment of the instrumentation kit of the invention, said first bundle of cables can be removably connected to at least one of said control unit and said display.

As already stated above in more general terms, a removable connection allows the control unit and/or the display to be quickly and easily disconnected as to remove them at any time after the installation of the instrumentation kit on the bicycle without requiring the removal of portions of bundles of cables or of other electronic components of the instrumentation kit.

Preferably, in this alternative embodiment, the first bundle of cables is connectible to at least one of the control unit and the display through a connector of an impermeable type.

Preferably, the first bundle of cables comprises at least five cables.

Preferably, the instrumentation kit further comprises a second bundle of cables to electrically connect at least one actuator of an equipment of said bicycle to said control unit and said second bundle of cables is cut off by a common connector to form two bundle portions connectible to each other through the connector.

Preferably, the instrumentation kit further comprises a third bundle of cables to electrically connect at least one second actuator of a second equipment of said bicycle to said control unit, in which said third bundle of cables is cut off by a common connector to form two bundle portions connectible to each other through the connector.

Preferably, the second and the third bundle of cables are cut off by the same common connector.

Preferably, such a common connector comprises a first connector element arranged as termination of two bundle portions and two second connector elements connectible to the first connector element each arranged as termination of a bundle portion.

Preferably, the second and/or third bundle of cables comprises at least six cables.

Preferably, the instrumentation kit further comprises a fourth bundle of cables to electrically connect at least one switch associated with a respective command device of the bicycle to said display.

Preferably, the instrumentation kit further comprises a fifth bundle of cables to electrically connect at least one second switch associated with a respective command device of the bicycle to said display.

Preferably, said fourth and fifth bundle of cables each comprise at least two cables, at least one of which is a ground cable intended to carry a reference signal.

In an embodiment of the instrumentation kit of the invention, the fourth and fifth bundle of cables are fixedly connected to the display.

In an alternative embodiment, the fourth and fifth bundle of cables are removably connectible to said display.

Preferably, in this alternative embodiment, the fourth and fifth bundle of cables are connectible to the display through a connector of an impermeable type.

Irrespective of the type of connection, the ground cables preferably connect to each other inside the display.

Preferably, each of said fourth and fifth bundle of cables is cut off by a common connector to form two bundle portions connectible to each other through such a common connector.

This allows the switches to be quickly and simply disconnected and to remove them at any time after installation of the instrumentation kit on the bicycle, without requiring the removal of the respective portions of bundle of cables or other electronic components of the instrumentation kit.

The invention further refers to a bicycle comprising an instrumentation kit according to the invention.

Preferably, such a bicycle, individually or in combination, has all of the structural and functional characteristics discussed above with reference to the instrumentation kit of the invention.

In particular, one or more of the bundles of cables of the instrumentation kit are preferably at least partially housed inside a component of the bicycle.

Preferably, the common connectors that connect respective portions of said bundles of cables are also housed inside a component of the bicycle.

In an embodiment of the bicycle of the invention, the component of the bicycle is a bottle holder.

In another embodiment of the bicycle of the invention, the component of the bicycle is the frame.

In a further embodiment of the bicycle of the invention, the component of the bicycle is the handlebars.

In a further embodiment of the bicycle of the invention, the component of the bicycle is a seat post.

Preferably, one or more of the bundles of cables of the instrumentation kit are immobilized inside the aforementioned component of the bicycle through mechanical fastening means.

Alternatively, the immobilization can be obtained through gluing substances or foaming substances.

In this way, irrespective of the specific immobilization method, the bundles of cables of the instrumentation kit are prevented from producing disturbing noises due to their impacts inside components of the bicycle.

The invention further refers to a bottle holder of a bicycle provided with an instrumentation kit comprising a bundle of cables for electrically connecting a first and second electronic component of the instrumentation kit, said bottle holder comprising a base support portion and a side support portion intended to be fixed to the frame of said bicycle, such that said side support portion comprises a collecting space adapted to receive at least one portion of said bundle of cables.

Preferably, the bottle holder comprises a tight seal gasket associated with said side support portion at a peripheral edge of said collecting space.

Preferably, the base support portion of the bottle holder comprises a space adapted to receive an electronic component of said first and second electronic component of the instrumentation kit.

More preferably, said electronic component is a control unit.

Preferably, the base support portion of the bottle holder is tightly sealed at at least one of its sides through a removable cover.

Preferably, said electronic component comprises a power supply unit and such a power supply unit is associated with the removable cover.

The invention further refers to a containment box for at least one electronic component of an instrumentation kit of a bicycle comprising a box-shaped element and a removable cover, wherein a tight seal gasket is arranged between the removable cover and the box-shaped element.

Preferably, the removable cover is associated with a power supply unit of the instrumentation kit.

Preferably, the containment box comprises a second box-shaped element forming a space for containing at least one second component of the instrumentation kit.

Preferably, the second box-shaped element has an opening defined by an outer peripheral edge having a shape such as to fit to a tube of a frame of said bicycle.

Preferably, the containment box comprises a gasket at said outer peripheral edge such as to make a tight seal between the outer peripheral edge and the tube of the frame.

### Detailed Description

The term “electronic component” should be taken in the wider sense to include, amongst other things, a battery, a switch, a display, an actuator, any circuit board, a control unit, etc.

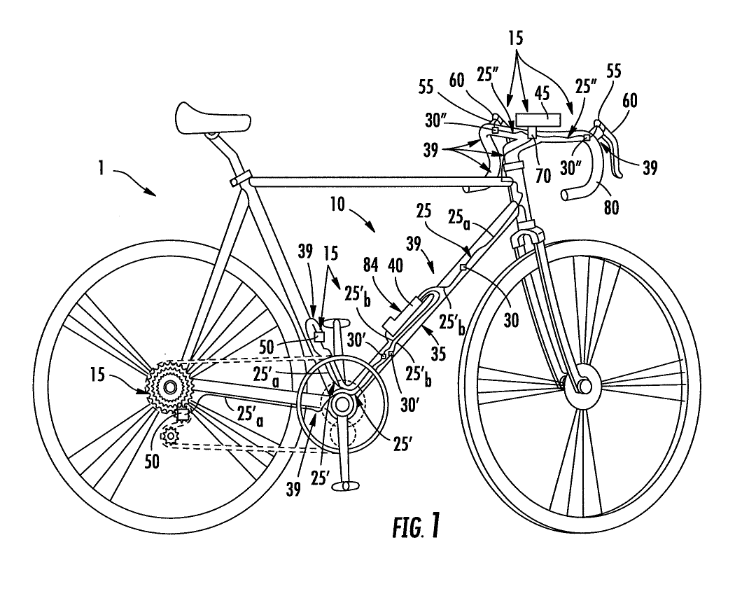

In FIG. 1, a bicycle on which an instrumentation kit 10 according to the present invention is mounted is wholly indicated with reference numeral 1.

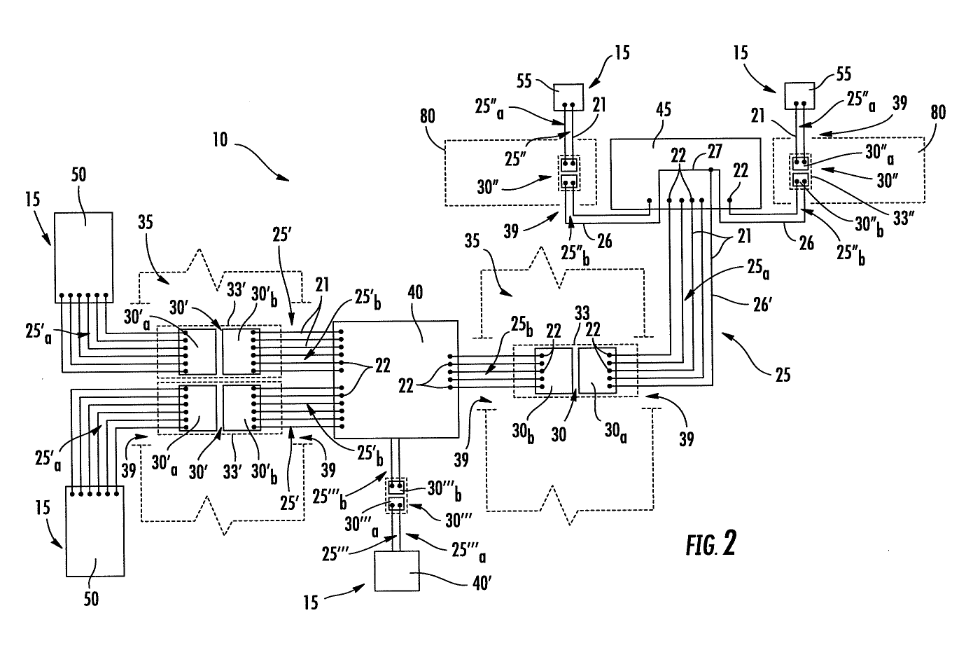

In general, the instrumentation kit 10 comprises a plurality of electronic components 15 electrically connected to each other with one component paired to another through cables 21. The plurality of cables 21 connecting two electronic components is hereafter referred to as a bundle of cables, for the sake of simplicity. In FIG. 2 six bundles of cables 25, 25′, 25″, 25′″ are represented. The cables 21 of each bundle of cables 25, 25′, 25″, 25′″ can be cut off by a respective common connector 30, 30′, 30″, 30′″ to form two bundle portions 25a, 25b, 25a′, 25b′, 25a″, 25b″, 25a′″, 25b′″. Such connectors are preferably of a non-impermeable type.

The connectors and the bundles of cables for at least a section of the respective lengths are housed inside components of the bicycle 1, such as for example the frame 35, the handlebars 80, a seat post or a bottle holder.

In FIG. 2 a first preferred embodiment of the instrumentation kit 10 is represented. The electronic components 15 in this case comprise a control unit 40 and a display 45, for example forming part of an on-board computer of the bicycle 1, a pair of actuators 50 to respectively actuate the front and rear derailleur (not shown in detail in the figures) of the bicycle 1, a pair of switches 55 associated with command devices 60 (FIG. 1) arranged on the handlebars of the bicycle 1, and a battery 40′.

When the cyclist gives a gearshifting order by acting upon the command devices 60, the switches 55 emit an electrical signal that is transmitted to the control unit 40, which in turn commands the actuators 50 to carry out gearshifting.

The display 45 and the control unit 40 are electrically connected through a first bundle of cables 25, preferably comprising at least five cables 2 1. The bundle of cables 25 is divided into two bundle portions 25a and 25b connectible through a first connector 30 common to all of the cables of the bundle 25. The connector 30 is of a non-impermeable type and in the mounted configuration of the instrumentation kit 10 it is inserted inside a component of the bicycle 1, in particular the frame 35. The bundle of cables 25 passes into the frame 35 through inlet and outlet holes 39.

In the embodiment of FIG. 2 the bundle portions 25a and 25b of the bundle of cables 25 are fixedly connected to the control unit 40 and to the display 45. In particular, each cable 21 of the bundle portions 25a and 25b is connected to such components at respective connection points 22 obtained through welding, crimping or another fastening method known by one skilled in the art.

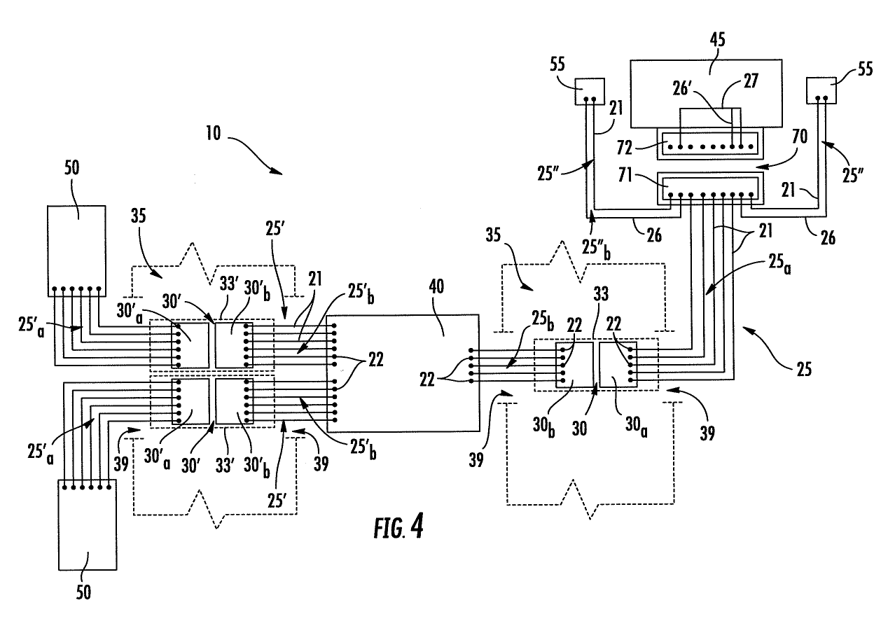

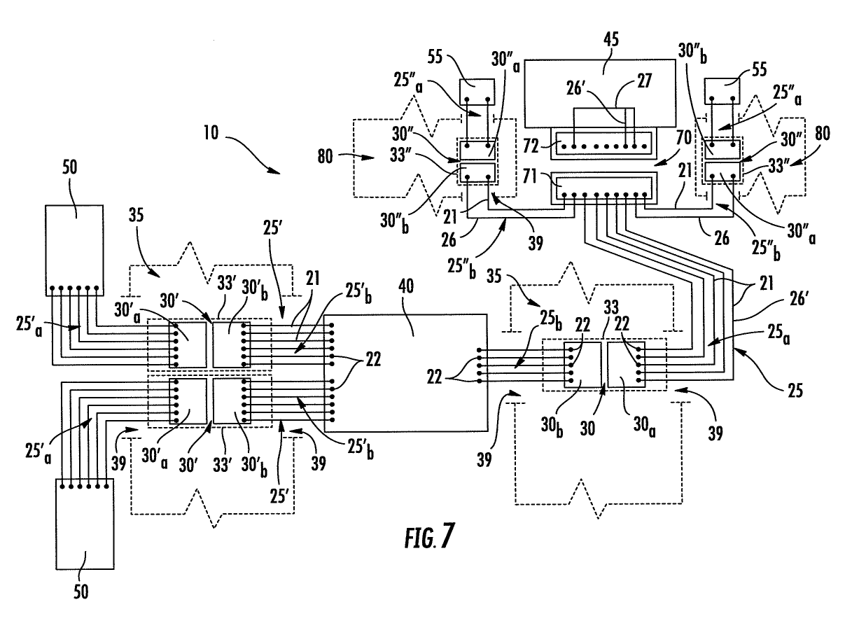

In alternative embodiments (FIGS. 4-7) the bundle of cables 25 can be removably connected to the display 45, through a connector 70 comprising a first connector element 71 associated with the bundle of cables 25 and a second connector element 72 associated with the display 45. The connector 70, being typically positioned outside of the bicycle 1, is preferably of an impermeable type.

The connector 30 comprises a first connector element 30b, for example a male element, and a second connector element 30a, for example a female element. The cables 21 of the bundle portions 25a and 25b are preferably fixedly connected to the connector elements 30b and 30a at respective connection points 22 obtained according to one of the fastening methods cited above.

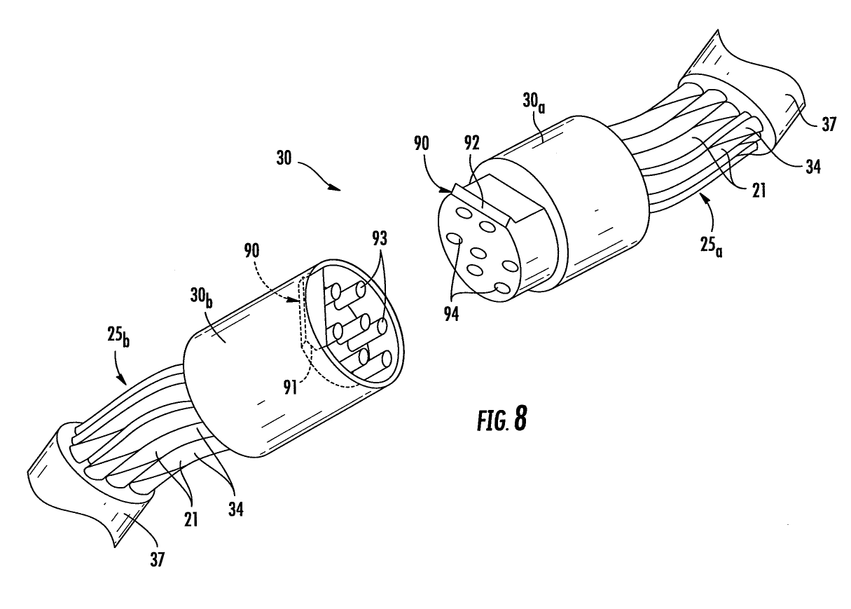

As shown in detail in FIG. 8, the first and the second connector element 30b and 30a are configured so as to allow a single coupling configuration, so that each portion of a cable 21 in the bundle portion 25b connected to the first connector element 30b can be connected only to the corresponding portion of a cable 21 in the bundle portion 25a connected to the second connector element 30a. In particular, each connector 30 has (FIG. 8) a plurality of pins 93 at the first connector element 30b and a corresponding plurality of sockets 94 at the second connector element 30a. A portion of a cable 21 is connected to each pin 93 and socket 94. Upon connection via the configuration of the first and second connector element 30b and 30a that allows a single mutual coupling position, each pin 93 inserts into a single and predetermined socket 94, so that the correct electrical connection between corresponding portions of cables 21 of the two bundle portions 25a and 25b is ensured.

FIG. 8 shows, as an example, a connector 30 having seven poles, i.e. with seven pins 93 and seven sockets 94. Typically, the number of poles corresponds to the number of cables 21 forming the bundle of cables 25. However, it is also possible to use a connector 30 with a number of poles greater than the number of cables 21 in the bundle of cables 25, where the excess poles are not connected to any cable 21.

As shown again in FIG. 8, the first and second connector element 30b and 30a comprise respective engagement elements 90 adapted to cooperate with each other to lock the connector elements 30b and 30a in their connected configuration. Purely as an example, in FIG. 8 the first connector element 30b comprises a recess or seat 91 adapted to cooperate with a projection or tooth 92 formed at the second connector element 30a. In general, any locking system that requires a minimum predetermined force to separate the connector elements 30b and 30a can be considered for the present invention. An alternative solution to the one described is, for example, that of making pins 93 and sockets 94 configured so as to require a predetermined force to couple them with each other.

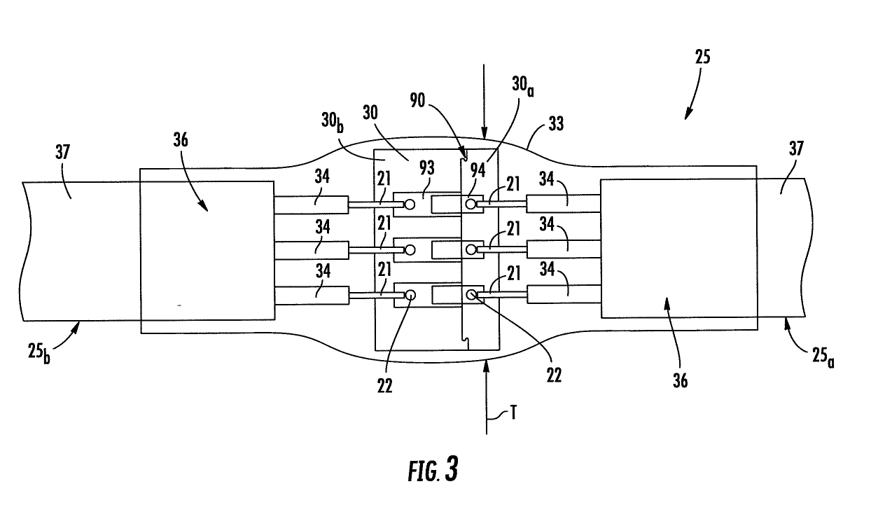

As can be seen from FIG. 3, which schematically shows the detail of two bundle portions 25a and 25b connected through the connector 30, each cable 21 is covered by a respective insulating sheath 34, and the cables 21 thus covered are in turn wholly covered by an insulating sheath 37 to respectively form the bundle portions 25a and 25b of the bundle of cables 25.

The connector 30, which is of a non-impermeable type as stated above, is made impermeable through the application of an insulating sheath 33. The insulating sheath 33 is applied so as to fully cover the connector 30 and possible parts of cables 21 bared for the connection to the connector 30, and further so as to overlap with the insulating sheath 37 at sections 36 adjacent to the connector 30. The overlapping with the insulating sheath 37 prevents humidity from penetrating inside the bundle portions 25 at the connection and from thus reaching the electronic components connected thereto.

The insulating sheath 33 is preferably made of a heat-shrinking material, which, when subjected to heating, shrinks making the outer insulating sheath 33 perfectly adhere to the connector 30 and to the sections 36 of the bundle portions 25a and 25b.

The thickness of the insulating sheaths 34 and 37 and of the outer insulating sheath 33 is preferably between about 0.1 and about 1 mm.

The maximum size T at a cross-section of the connector 30 coated by the outer insulating sheath 33 is preferably between about 5 and about 7 mm.

It should be observed that although FIG. 3 shows, as an example, bundle portions 25 respectively comprising 3 cables 21, what has been explained is independent of the number of cables 21 in the bundle portions 25a and 25b.

Returning to the scheme of FIG. 2, between each of the actuators 50 and the control unit 40 an electrical connection similar to the one described above with reference to the electrical connection between display 45 and control unit 40 is provided. In particular, each of the actuators 50 is connected to the control unit 40 respectively through a second and a third bundle of cables 25′, each preferably comprising at least six cables 21. Each bundle of cables 25′ is divided into two bundle portions 25a′ and 25b′ connectible to each other through a common connector 30′, of a non-impermeable type. Each connector 30′ comprises a respective first connector element 30b′ and a respective second connector element 30a′ and, in the connected configuration, is covered by an outer insulating sheath 33′ made of heat-shrinking material, in a way totally similar to that described above with reference to the outer insulating sheath 33.

Also in this case the connectors 30′ and at least a section of the bundles of cables 25′ are housed inside a component of the bicycle 1, in particular the frame 35, by means of inlet and outlet holes 39.

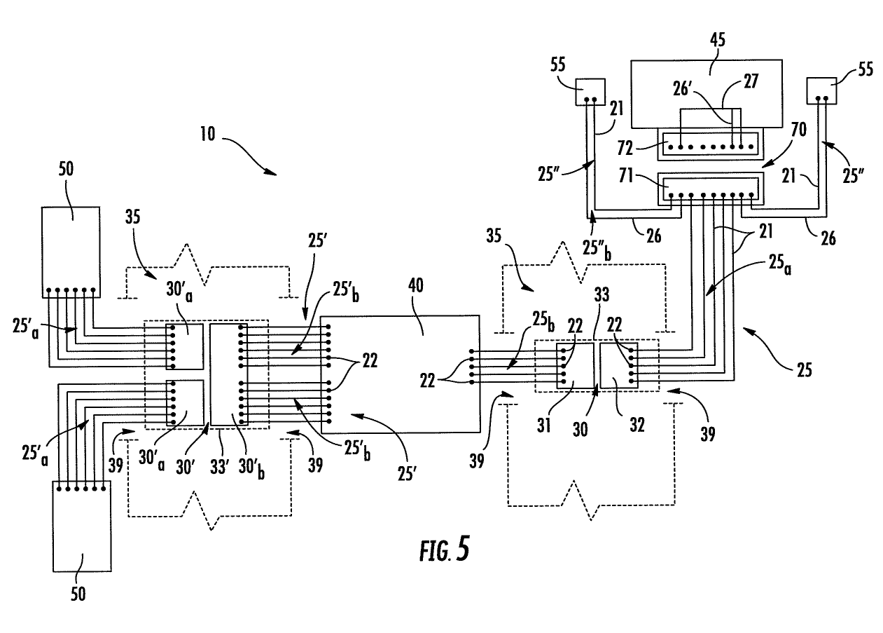

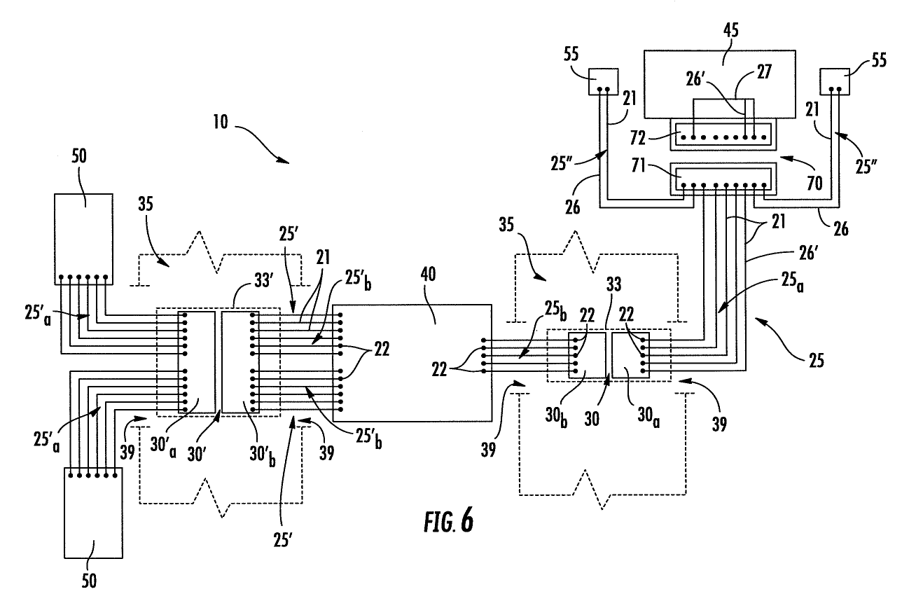

In alternative embodiments (FIGS. 5 and 6) the respective bundle portions 25a′ and 25b′ of the bundles of cables 25′ are connected to each other through a connector 30′ having at least one connector element shared between two bundle portions 25a′ or 25b′. For example, FIG. 5 shows an embodiment of the instrumentation kit 1 in which both of the bundle portions 25b′ of the two bundles 25′, each comprising six portions of cables 21, is connected to the control unit 40 and to a connector element 30b′, for example of the female type, shared between both of the bundle portions 25b′. The two bundle portions 25a′, each comprising six cable portions 21, are connected to respective connector elements 30a′, for example of the male type, and to respective actuators 50. Both of the male connector elements 30a′ are connected to the single female connector 30b′. In FIG. 6 also the two bundle portions 25a′ are connected to a connector element 30a′ shared between both of such portions.

Again with reference to the scheme of FIG. 2, each switch 55 is connected to the display 45 respectively through a fourth and a fifth bundle of cables 25″. Each bundle of cables 25″ preferably comprises at least two cables 21, one of which is a ground cable, indicated with reference numeral 26, intended to carry a reference signal. The ground cables 26 connect to each other and to a ground cable 26′ of the bundle of cables 25 preferably inside the display 45, as schematically illustrated by the connection 27.

In the embodiment of FIG. 2 the bundles of cables 25″ are fixedly connected both to the switches 55 and to the display 45 at connection points 22 obtained according to the methods described above. The bundles of cables 25″ are also preferably, but not necessarily, cut off by a respective common connector 30″ to form respective bundle portions 25a″ 25b″ connectible to each other through the connectors 30″. Each connector 30″, is preferably of a non-impermeable type and is made impermeable through the application of an outer insulating sheath 33″, in a way similar to that described above with reference to the connectors 30 and 30′. The connectors 30″ are preferably inserted inside a component of the bicycle 1, for example, in the handlebars 80 via holes 39.

In alternative embodiments (FIGS. 4-7) the bundles of cables 25″ are removably connectible to the display 45. In this case, the connection is made by using the same connector 70 that connects the bundle of cables 25 to the display 45. Also in these embodiments the ground cables 26 are connected to each other inside the display 45 through a connection 27 suitably arranged between terminals of the connector element 72 associated with the display 45.

The control unit 40 preferably comprises a logic unit of the instrumentation kit 10 and a power unit that powers and controls the actuators. The control unit can itself contain a battery or power supply unit 40′ or alternatively, as illustrated in FIG. 2, the control unit can be connected to the battery or power supply through a sixth bundle of cables 25′″, in which case the power supply unit 40′ can also be located at a different location than the control unit 40. The bundle of cables 25′″ is also preferably divided into two bundle portions 25a′″ and 25b′″ by a common connector 30′″, comprising two connector elements 30a′″ and 30b′″.

Preferably, in each of the described embodiments some or all of the bundles of cables 25, 25′, 25″ and 25′″ have a length greater than the length corresponding to the path that they must follow inside the bicycle 1 to connect the respective electronic components 15 with which they are associated. The exceeding sections of the bundles make it possible to work on the connectors 30, 30′, 30″ and 30′″ easily outside of the bicycle 1 and, in the mounted configuration of the instrumentation kit 10, they can be housed in suitable collecting spaces. Such collecting spaces can be defined at components of the bicycle 1, such as, for example, the frame 35, the handlebars 80, a seat post or a bottle holder, or else they can be associated with one or more of the electronic components 15 of the instrumentation kit 10, such as, for example, the display 45 or the actuators 50.

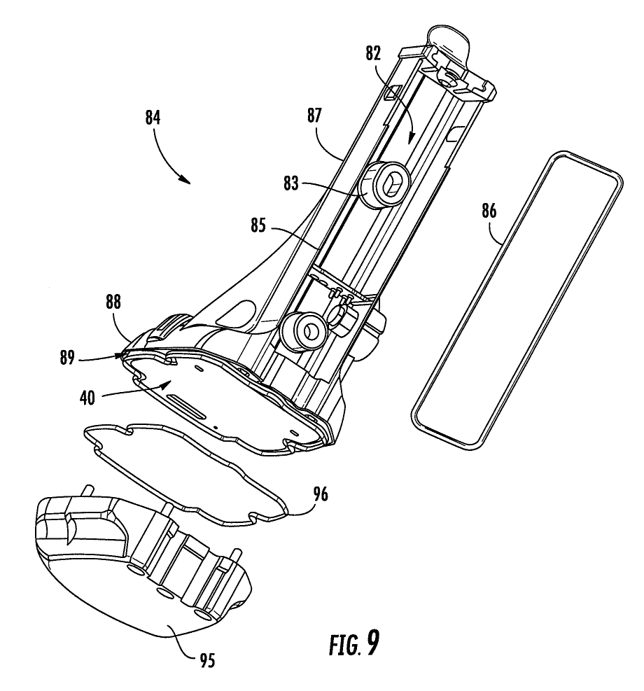

In a preferred embodiment of the instrumentation kit 10 of the invention, it is provided to define a collecting space 82 in a support of the control unit 40 integrated in a bottle holder 84 as illustrated in FIG. 9.

The bottle holder 84 comprises a side support portion 87 of a bottle and a base support portion 88 of the bottle, preferably substantially perpendicular to each other and made in a single piece.

The collecting space 82 is defined in the side support portion 87 and comprises an appropriately sized cavity in which there is at least one separator element 83 of the bundles of cables 25, 25′ and possibly 25′″, so that the latter can be kept inside the collecting space 82 without twisting around one another.

The collecting space 82 has an opening delimited by a peripheral edge 85 of the side support portion 87. The latter is intended to be fixed to the frame 35 of the bicycle 1 according to methods known to one skilled in the art, such that when the bottle holder 84 is mounted on the bicycle 1, the frame closes the opening of the collecting space 82 and prevents the bundles of cables from coming out. At the peripheral edge 85 a gasket 86 is preferably arranged, so as to make the collecting space 82 tightly sealed. It is also possible to receive the connectors 30 and 30′ and possibly 30′″ in the collecting space 82, instead of in the frame 35.

The base support portion 88 comprises a space 89 adapted to receive the control unit 40. The space 89 is preferably closed through a removable cover 95. A gasket 96 ensures the tight seal of the cover 95. A power supply unit of the control unit 40 is preferably associated with the removable cover 95.

Irrespective of its arrangement, the size of the collecting space 82 is preferably such as to allow the exceeding sections of the bundles of cables to be completely received and immobilized, so that such exceeding sections do not have to be housed in the frame 35, where, being looser, they would produce noise due to impact with the walls.

In any case, special systems for immobilizing the bundles of cables 25, 25′ and 25″ can be considered. Such systems provide for the use of mechanical fastening means, the use of gluing substances applied to the inner walls of the frame 35 or the use of foaming substances introduced inside the frame 35. In the case of gluing substances, it is possible to use either non-setting glues, so that the bundles of cables can be removed by applying a sufficient force to overcome the viscosity, or setting glues, so that the bundles of cables definitively stick to the frame. The bundles of cables 25″ can be immobilized in the handlebars in the same way.

As an alternative to the use of the aforementioned immobilization systems, it is possible to use insulating sheaths 34 for the cables 21, or 37 for the bundles of cables 25, 25′, 25″ and 25′″ made from a polymeric material with a Shore A hardness lower than that of the insulating sheaths for common electrical cables, and preferably between about 5 and about 40, more preferably between 10 and 20. In this way, even if a cable or a bundle of cables impacts the walls of the frame 35, it does not generate noise.

Preferred polymeric materials for this purpose are silicon-based materials.

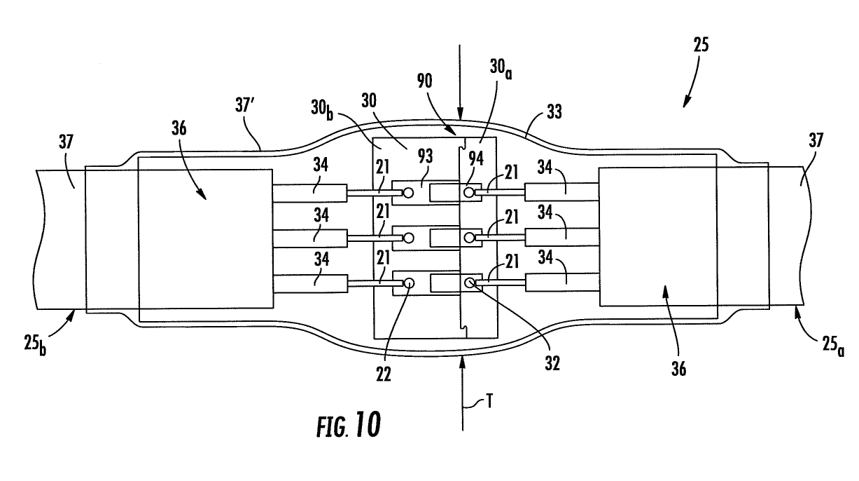

As shown in FIG. 10, which refers by example to connector 30, the connectors 30, 30′, 30″ and 30′″ can be covered by an insulating sheath with a low Shore A hardness. Particularly, it is possible to use the same insulating sheath 37 as that of the bundle portions 25a and 25b connected through the connector 30, either in the form of an extension of the portion of insulating sheath that covers the cables 21, or in the form of a distinct portion of an insulating sheath 37′. In this case, the aforementioned thickness T also comprises the insulating sheath 37′.

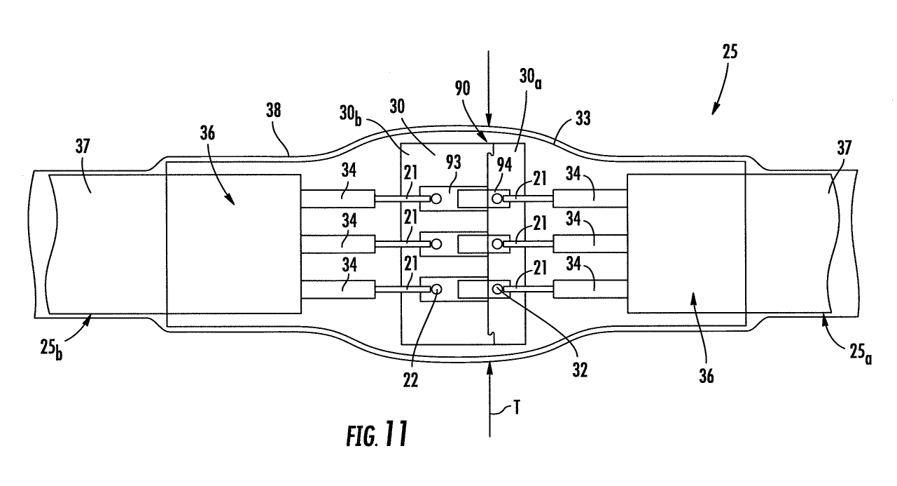

Alternatively, as shown in FIG. 11, a fourth sheath 38 of polymeric material with low Shore A hardness is used to cover the entire bundle 25, also wrapping around the connector 30.

As to the form of the connectors 30, 30′, 30″, 30′″, only one example has been illustrated in FIG. 8 by way of example, in which the connections of the various cables 21 are arranged in parallel with each other. However, the form of the connector is not limiting for the purposes of the present invention and can be varied, for example by adopting a form with connections between the various cables 21 arranged in series with each other, as illustrated in patent U.S. Pat. No. 6,634,896, herein incorporated here by reference.

One skilled in the art shall recognize that it is possible to combine the various characteristics of the embodiments described above to obtain further embodiments, any of which fall within the scope of the present invention as defined by the following claims.

What is claimed is:

1. Instrumentation kit of a bicycle comprising a bundle of cables for electrically connecting a first electronic component of the kit to a second electronic component of the kit, the cables of the bundle being cut off to form a first bundle portion and a second bundle portion, wherein said first bundle portion and said second bundle portion are connectible to each other through a common connector.

2. The instrumentation kit of claim 1, wherein said common connector comprises a first connector element associated with said first bundle portion and a second connector element associated with said second bundle portion, said first and second connector element being adapted to be coupled to each other in a single coupling configuration.

3. The instrumentation kit of claim 2, wherein said first and second connector element comprise respective engagement elements adapted to cooperate to lock said connector in the configuration in which said first and second bundle portion are connected to each other.

4. The instrumentation kit of claim 3, wherein one of said first and second connector element comprises a projection and the other comprises a recess adapted to receive said projection.

5. The instrumentation kit of claim 2, wherein a stable connection is established between said first and second connector elements through an insertion force required to mate said first and second connector elements.

6. The instrument kit of claim 5, wherein the first and second connector elements are secured by a mechanical fastener.

7. The instrument kit of claim 5, wherein the first and second connector elements are secured by an adhesive.

8. The instrumentation kit of claim 1, wherein at least one of said first and second electronic component of the kit is electrically connected to a third electronic component of the kit through a further bundle of cables.

9. The instrumentation kit of claim 8, wherein said further bundle of cables is cut off to form a first bundle portion and a second bundle portion, said first bundle portion and said second bundle portion being connectible to each other through a common connector.

10. The instrumentation kit of claim 9 wherein said first bundle portion of said bundle of cables and said first bundle portion of said further bundle of cables are both associated with said first connector element, and wherein said second bundle portion of said bundle of cables and said second bundle portion of said further bundle of cables are respectively associated with two distinct second connector elements.

11. The instrumentation kit of claim 10, wherein said two distinct second connector elements are adapted to be coupled with said first connector element in a single coupling configuration.

12. The instrumentation kit of claim 9 wherein said first bundle portion of said bundle of cables and said first bundle portion of said further bundle of cables are associated with two distinct connector elements, and wherein said second bundle portion of said bundle of cables and said second bundle portion of said further bundle of cables are both associated with said second connector element.

13. The instrumentation kit of claim 12, wherein said two distinct first connector elements are adapted to be coupled with said second connector element in a single coupling configuration.

14. The instrumentation kit of claim 1, wherein said bundle of cables is fixedly connected to at least one of said first and second electronic component of the kit.

15. The instrumentation kit of claim 1, wherein said bundle of cables is removably connectible to at least one of said first and second electronic component of the kit.

16. The instrumentation kit of claim 1, wherein said common connector is of a non-impermeable type.

17. The instrumentation kit of claim 1, wherein said bundle of cables comprises from two to twenty-four cables.

18. The instrumentation kit of claim 1, wherein each cable of said first and second bundle of cables is covered by a respective first insulating sheath.

19. The instrumentation kit of claim 18, wherein the first insulating sheath is comprised of a polymeric material having a Shore A hardness between 5 and 40.

20. The instrumentation kit of claim 18, wherein the first insulating sheath is comprised of a polymeric material having a Shore A hardness between 10 and 20.

21. The instrumentation kit of claim 18, wherein the first insulating sheath is comprised of a silicon-based material.

22. The instrumentation kit of claim 18, wherein the first insulating sheath has a thickness between 0.1 and 1 mm.

23. The instrumentation kit of claim 1, wherein said first and second bundle portion are wrapped in a respective second insulating sheath.

24. The instrumentation kit of claim 23, wherein the second insulating sheath is comprised of a polymeric material having a Shore A hardness between 5 and 40.

25. The instrumentation kit of claim 23, wherein the second insulating sheath is comprised of a polymeric material having a Shore A hardness between 10 and 20.

26. The instrumentation kit of claim 23, wherein the second insulating sheath is comprised of a silicon-based material.

27. The instrumentation kit of claim 23, wherein the second insulating sheath has a thickness between 0.1 and 1 mm.

28. The instrumentation kit of claim 1, further comprising a third insulating sheath covering said common connector when said first and second bundle portion are connected.

29. The instrumentation kit of claim 28, wherein said third insulating sheath overlaps with said first or second insulating sheath for at least a portion of said first and second bundle portion close to said common connector, or vice-versa.

30. The instrumentation kit of claim 28, wherein said second insulating sheath completely covers said third insulating sheath.

31. The instrumentation kit of claim 28, wherein said third insulating sheath is made of a heat-shrinking material.

32. The instrumentation kit of claim 28, wherein a fourth insulating sheath completely covers said first and second bundle portion connected by the common connector and said common connector.

33. The instrumentation kit of claim 32, wherein the fourth insulating sheath is made of a polymeric material having a Shore A hardness between 5 and 40.

34. The instrumentation kit of claim 32, wherein the polymeric material has a Shore A hardness between 10 and 20.

35. The instrumentation kit of claim 32, wherein the polymeric material is a silicon-based material.

36. The instrumentation kit according of claim 32, wherein the fourth insulating sheath has a thickness between 0.1 and 1 mm.

37. The instrumentation kit of claim 32, wherein the maximum size (T) at a cross-section of said common connector covered by one or more insulating sheaths is between 5 and 7 mm.

38. The instrumentation kit of claim 1, wherein at least one of said first and second bundle portion is fixedly connected to a respective component of said first and second electronic component.

39. The instrumentation kit of claim 38, wherein at least one of said first and second bundle portion is connected to a respective component of said first and second electronic component through welding or crimping.

40. The instrumentation kit of claim 1, wherein at least one of said first and second bundle portion is removably connectible to a respective component of said first and second electronic component.

41. The instrumentation kit of claim 40, wherein at least one of said first and second bundle portion is connectible to a respective component of said first and second electronic component through at least one terminal board or at least one connector.

42. The instrumentation kit of claim 40, wherein said at least one connector is a connector of an impermeable type.

43. The instrumentation kit of claim 1, wherein said bundle of cables comprises a section exceeding the length required to connect said first and second electronic component when installed on said bicycle.

44. The instrumentation kit of claim 43, wherein said common connector is associated with said bundle of cables at said exceeding section.

45. The instrumentation kit of claim 43, comprising a collecting space provided to house said exceeding section of said bundle of cables.

46. The instrumentation kit of claim 45, wherein said collecting space comprises at least one separator element adapted to separate a plurality of bundles of housed in the space from each other.

47. The instrumentation kit of claim 45, wherein said collecting space is defined at a bottle holder of said bicycle.

48. The instrumentation kit of claim 47, wherein said collecting space is integrated in said bottle holder.

49. The instrumentation kit of claim 47, wherein said bottle holder comprises a base support portion and a side support portion intended to be fixed to the frame of said bicycle, and said collecting space is defined in said side support portion.

50. The instrumentation kit of claim 49, wherein said bottle holder comprises a tight seal gasket associated with said side support portion at a peripheral edge of said collecting space.

51. The instrumentation kit of claim 49, wherein said base support portion comprises a space adapted to receive an electronic component of said first and second electronic component.

52. The instrumentation kit of claim 51, wherein said electronic component is a control unit.

53. The instrumentation kit of claim 51, wherein said base support portion of the bottle holder is tightly sealed along at least one of its sides through a removable cover.

54. The instrumentation kit of claim 53, wherein said electronic component is provided with a power supply unit and said power supply unit is associated with said removable cover.

55. The instrumentation kit of claim 45, wherein said collecting space is defined at the frame of said bicycle.

56. The instrumentation kit of claim 45, wherein said collecting space is defined at the handlebars of said bicycle.

57. The instrumentation kit of claim 45, wherein said collecting space is defined at a seat post of said bicycle.

58. The instrumentation kit of claim 45, wherein said collecting space is associated with one of said two electronic components.

59. The instrumentation kit of claim 1, wherein said first and second electronic component comprise a control unit and a display of an on-board computer of said bicycle.

60. The instrumentation kit of claim 59, wherein said control unit comprises a logic unit and a power unit for controlling the actuators.

61. The instrumentation kit of claim 59, comprising a first bundle of cables to electrically connect said control unit and said display, wherein said first bundle of cables is fixedly connected to said control unit and to said display.

62. The instrumentation kit of claim 59, comprising a first bundle of cables to electrically connect said control unit and said display, wherein said first bundle of cables is removably connectible to at least one of said control unit and said display.

63. The instrumentation kit of claim 62, wherein said first bundle of cables is connectible to at least one of said control unit and said display through a connector of an impermeable type.

64. The instrumentation kit of claim 62, wherein said first bundle of cables comprises at least five cables.

65. The instrumentation kit of claim 62, further comprising a second bundle of cables to electrically connect at least one actuator of an equipment of said bicycle to said control unit, wherein said second bundle of cables is cut off by a common connector to form two bundle portions connectible to each other through the connector.

66. The instrumentation kit of claim 65, further comprising a third bundle of cables to electrically connect at least one second actuator of a second equipment of said bicycle to said control unit, wherein said third bundle of cables is cut off by a common connector to form two bundle portions connectible to each other through the connector.

67. The instrumentation kit of claim 66, wherein the second and third bundle of cables are cut off by the same common connector.

68. The instrumentation kit of claim 67, wherein the common connector comprises a first connector element arranged as termination of two bundle portions and two second connector elements connectible to the first connector element each arranged as termination of a bundle portion.

69. The instrumentation kit of claim 66, wherein said second and/or third bundle of cables comprise at least six cables.

70. The instrumentation kit of claim 66, further comprising a fourth bundle of cables to electrically connect at least one switch associated with a respective command device of said bicycle to said display.

71. The instrumentation kit of claim 70, further comprising a fifth bundle of cables to electrically connect at least one second switch associated with a respective command device of said bicycle to said display.

72. The instrumentation kit of claim 71, wherein said fourth and fifth bundle of cables each comprise at least two cables, at least one of which is a ground cable intended to carry a reference signal.

73. The instrumentation kit of to claim 71, wherein said fourth and fifth bundle of cables are fixedly connected to said display.

74. The instrumentation kit of claim 71, wherein said fourth and fifth bundle of cables are removably connectible to said visual display.

75. The instrumentation kit of claim 71, wherein said fourth and fifth bundle of cables are connectible to said display through a connector of an impermeable type.

76. The instrumentation kit of claim 71, wherein said ground cables connect to each other inside said display.

77. The instrumentation kit of claim 71, wherein each of said fourth and fifth bundle of cables is cut off by a common connector to form two bundle portions connectible to each other through the common connector.

78. A bicycle comprising a bundle of cables for electrically connecting a first electronic component of the kit to a second electronic component of the kit, the cables of the bundle being cut off to form a first bundle portion and a second bundle portion, wherein said first bundle portion and said second bundle portion are connectible to each other through a common connector.

79. The bicycle of claim 78, wherein said common connector is housed inside a component of the bicycle.

80. The bicycle of claim 79, wherein said bundle of cables is at least partially housed inside a component of the bicycle.

81. The bicycle of claim 80, wherein said bundle of cables is immobilized inside said component of the bicycle through mechanical fastening means.

82. The bicycle of claim 82, wherein said bundle of cables is immobilized inside said component of the bicycle through gluing substances.

83. The bicycle of claim 82, wherein said bundle of cables is immobilized inside said component of the bicycle through foaming substances.

84. The bicycle of claim 79, wherein said component of the bicycle is a bottle holder.

85. The bicycle of claim 79, wherein said component of the bicycle is the frame.

86. The bicycle of claim 79, wherein said component of the bicycle is the handlebars.

87. The bicycle of claim 79, wherein said component of the bicycle is a seat post.

88. A bottle holder of a bicycle comprising a bundle of cables for electrically connecting a first and a second electronic component of the instrumentation kit, said bottle holder comprising a base support portion and a side support portion intended to be fixed to the frame of said bicycle, wherein said side support portion comprises a collecting space adapted to receive at least one portion of said bundle of cables.

89. The bottle holder of claim 88, comprising a tight seal gasket associated with said side support portion at a peripheral edge of said collecting space.

90. The bottle holder of claim 88, wherein said base support portion comprises a space adapted to receive an electronic component of said first and second electronic component.

91. The bottle holder of claim 90, wherein said electronic component is a control unit.

92. The bottle holder of claim 88, wherein said base support portion is tightly sealed along at least one of its sides through a removable cover.

93. The bottle holder of claim 92, wherein said electronic component comprises a power supply unit and said power supply unit is associated with said removable cover.

94. A containment box for at least one electronic component of an instrumentation kit of a bicycle comprising a box-shaped element and a removable cover, wherein a tight seal gasket is arranged between said removable cover and said box-shaped element.

95. The containment box of claim 94, wherein said removable cover is associated with a power supply unit of the instrumentation kit.

96. The containment box of claim 95, further comprising a second box-shaped element forming a space for containing at least one second component of the instrumentation kit.

97. The containment box according to claim 96, wherein said second box-shaped element has an opening defined by an outer peripheral edge having a shape such as to fit to a tube of a frame of said bicycle.

98. The containment box of claim 97, comprising a gasket at said outer peripheral edge such as to make a tight seal between the outer peripheral edge and the tube of said frame.

99. An instrumentation kit of a bicycle comprising a bundle of cables the bundle of cables having a length sufficient to electrically connect a first electronic component positioned in a predetermined point of the bicycle with a second electronic component positioned in a different predetermined point of the bicycle, the length being also sufficient to allow the bundle of cables to pass at least partially inside the bicycle, and wherein said bundle of cables is divided into at least two distinct portions connectible with each other by a connector positioned at a point of said bundle of cables such that, said connector can be located inside the bicycle.

100. An instrumentation kit of a bicycle comprising a bundle of cables having a length sufficient to electrically connect a first electronic component positioned on or near a handlebar of the bicycle with a second electronic component positioned on a frame of the bicycle, said length being also sufficient to allow the bundle of cables to pass at least partially inside the frame of the bicycle, and wherein said bundle of cables is divided into at least two distinct portions connectible with each other by a connector positioned at a point of said bundle of cables such that, said connector can be located inside the frame of the bicycle.

101. An instrumentation kit of a bicycle comprising a bundle of cables having a length sufficient to electrically connect a first electronic component positioned on or near a handlebar of the bicycle with a second electronic component, said second component being one of the following: an electronic component seated in a bottle holder fixed to the bicycle frame, an electronic front derailleur, and an electronic rear derailleur, the length being also sufficient to allow the bundle of cables to pass at least partially inside a frame of the bicycle, and wherein said bundle of cables is divided into at least two distinct portions connectible to each other by a connector positioned at a point of said bundle of cables such that, said connector can be located inside the frame of the bicycle.

102. An instrumentation kit of a bicycle comprising a bundle of cables having a length sufficient to electrically connect a first electronic component positioned in a predetermined point of a frame of the bicycle with a second electronic component, said second electronic component being one of the following: an electronic component positioned on or near the handlebar of the bicycle, an electronic front derailleur, and an electronic rear derailleur, the length being also sufficient to allow the bundle of cables to pass at least partially inside the bicycle, and wherein said bundle of cables is divided into at least two distinct portions connectible to each other by a connector positioned at a point of said bundle of cable such that, in the use, said connector can be seated inside the bicycle.
